(19) United States
(12) Patent Application Publication
(10) Pub. No.: US 2015/0274004 A1
(43) Pub. Date: Oct. 1, 2015

(54) FUEL TANK AUXILIARY LINE

(71) Applicant: FORD GLOBAL TECHNOLOGIES, LLC, Dearborn, MI (US)

(72) Inventor: ANDREAS FRANKE, SOLINGEN (DE)

(21) Appl. No.: 14/669,059

(22) Filed: Mar. 26, 2015

(30) Foreign Application Priority Data
Mar. 27, 2014 (DE) 102014205743.4

(51) Int. Cl. B60K 15/01; B23P 19/00; B60K 15/03

(52) U.S. Cl. CPC B60K 15/01; B60K 15/03; B23P 19/00; B60K 2015/03236; B60K 2015/03328

(57) ABSTRACT

A fuel tank having at least one auxiliary fuel pick up line, in addition to the engine fuel pick up line, which supplies at least one auxiliary unit with fuel from the fuel tank, wherein a inlet is introduced as a side or lateral opening into a wall of the auxiliary line at a distance from a closed tank end of the auxiliary line, and wherein the tank end is closed and rests on a fuel tank bottom.

### CROSS REFERENCE TO RELATED APPLICATIONS

This application claims priority to application 102014205743.4, filed in the German Patent and Trademark Office on Mar. 27, 2014, which is hereby incorporated by reference in its entirety.

### STATEMENT REGARDING FEDERALLY SPONSORED RESEARCH

Not Applicable.

### BACKGROUND OF THE INVENTION

The present invention relates in general to fuel extraction from a fuel tank in a road vehicle, and, more specifically, to auxiliary fuel pick up line structures and methods.

An internal combustion motor vehicle has a fuel supply system. The system typically has a fuel tank having an active or passive fuel delivery module in order to supply the internal combustion engine with fuel via fuel lines. The fuel lines are passed through a tank flange into the interior of the fuel tank. The fuel lines may comprise a multiplicity of lines, which can be configured as pipes, as flexible hoses or the like.

In addition to supplying a gasoline spark-ignition or diesel internal combustion engine, auxiliary units can be supplied with fuel from the fuel tank. Such auxiliary units can be heaters, such as parking heaters or cab heaters, which can be present in, for example, motor vehicles and camper vans. For this purpose, at least one additional line is passed into the fuel tank. This auxiliary fuel pick up line can be attached to an opening or passed through the tank flange or the tank casing into the interior of the fuel tank.

A fuel intake end of the auxiliary line is located above the lower surface of the fuel tank and above the primary fuel intake so that the internal combustion engine is preferentially supplied with fuel. Thus, operation of auxiliary units would not deplete all tank fuel. Sufficient fuel would remain in the fuel tank to operate the internal combustion engine, even if the auxiliary unit or units are being operated, without the operator managing fuel consumption of auxiliary units. If the fuel level in the fuel tank falls below the level of the suction opening of the at least one auxiliary line, the corresponding unit is no longer supplied with fuel, and its operation ceases for lack of fuel. Remaining fuel in the fuel tank would be accessible to the primary fuel pick up line, with an intake lower than the auxiliary line, so that the vehicle could be driven to a gas station or other location to refuel.

Auxiliary fuel pick up lines can deform, stretch, warp, bend, and age in the course of time. As a result, the line inlet end of the auxiliary fuel pick up line may approach the fuel tank bottom and the original margin, with respect to the distance to the bottom of the fuel tank, is not maintained. Thus, the remaining fuel volume can be depleted inadvertently. In some instances, the fuel tank may be completely emptied by operation of the auxiliary unit, with no fuel remaining for the internal combustion engine.

If the opening of the at least one auxiliary fuel pick up line is in contact with the fuel tank bottom, there is also a greater chance that contaminants may be drawn in by the auxiliary fuel pick up line. Contaminants, such as particulates, sediments, and water may cause damage or impaired functioning of an auxiliary unit.

As the distance between the end of the auxiliary fuel pick up line and the fuel tank bottom decreases, the auxiliary line, hanging free in the fuel tank, may strike the fuel tank bottom during vehicle motion. For example, potholes and road bumps may impact vehicle dynamics such that a tank end of an auxiliary fuel pick up line, if it is elongated and free-hanging, may strike an interior surface of the tank and cause unwanted sounds.

Therefore, there is a need for improved auxiliary fuel pick up line systems and designs for providing at least one auxiliary line within a fuel tank.

### SUMMARY OF THE INVENTION

Described is a fuel tank with an auxiliary fuel pick up line for conveying fuel. The auxiliary fuel pick up line has a closed tank end, or terminus, that abuts the inner lower surface of the tank. The line inlet is located above the terminus. In some embodiments, the terminus is conical. In some embodiments, the terminus is a conical cover. In some embodiments, the teminus has an integrated filter. In some embodiments, the terminus is a sleeve over a section of the auxiliary line. In some embodiments, the terminus is shaped like an inverted pyramid.

In some embodiments, a distance between the inlet and the lower surface of the tank corresponds to a fuel volume capacity of about 1-5 gallons or 3-20 liters when the vehicle is level.

In some embodiments the fuel pick up line enters the tank through a removable fuel tank lid or flange. In other embodiments the fuel pick up line enters the tank through a casing or wall of the fuel tank.

In some embodiments the fuel system provides for a fuel reserve capacity, a reduction in contamination, a reduction in deformation stress on the line, and a reduction in force and frequency of impacts between the line and the tank.

In accordance with the foregoing aspects of the invention, exemplary methods, systems, designs, and structures are provided. Further features and aspects of the invention will be apparent from the descriptions, figures, examples, and claims provided herewith.

### BRIEF DESCRIPTION OF THE DRAWINGS

FIG. 1 shows a schematic representation of a prior art fuel tank having an auxiliary line.

FIG. 2 shows a tank end of the auxiliary line of FIG. 1.

FIG. 3 shows a schematic representation of a fuel tank having an auxiliary fuel pick up line.

FIG. 4 shows an end of the auxiliary line as a sectional drawing.

FIG. 5 shows a perspective view of the end of the auxiliary line with an integrated terminal closure.

FIG. 6 shows a perspective view of the end of the auxiliary line with an attachable terminal closure.

### DETAILED DESCRIPTION OF PREFERRED EMBODIMENTS

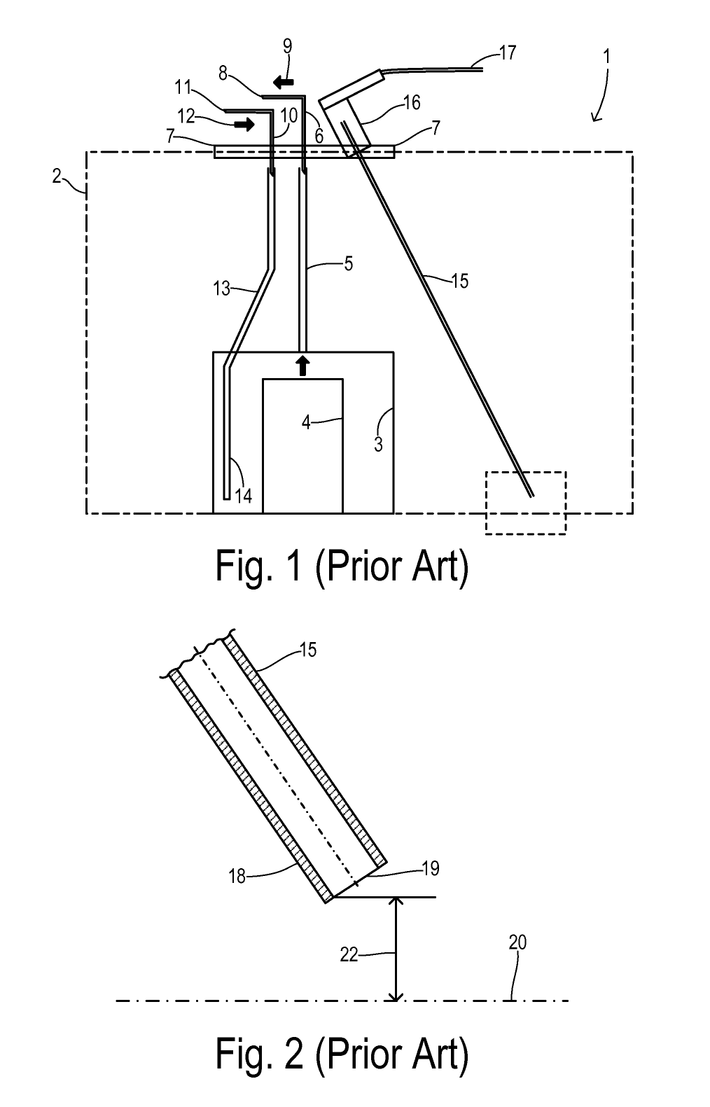

FIGS. 1 and 3 illustrate schematically a generalized view of a fuel delivery system 1. The example is an illustrative embodiment of a fuel system such as in a passenger car. The fuel delivery system 1 comprises a fuel tank 2, enclosing a fuel delivery module 3, containing a fuel pump 4 and a fuel filter (not shown). The fuel delivery module 3 connects to a first hose-type fuel line, also referred to as a primary fuel pick up line 5, or, in general, as a hydraulic line. The primary fuel pick up line 5 passes through a tank flange 7 by a primary line conduit 6. The primary line conduit 6 is integrated into the tank flange 7 and has a primary connection piece 8. An internal combustion engine (not shown) can be supplied with fuel by means of suitable elements attached to the primary connection piece 8.

The tank flange 7 is configured such that it can be fitted into an opening in the fuel tank 2 and thus closes and seals the tank. Fuel, such as gasoline or diesel, in the fuel tank is conveyed to the internal combustion engine by the fuel delivery module 3 in accordance with the arrow 9 shown.

A fuel return is shown. The tank flange 7 has a return line conduit 10 with a return connection piece 11, through which excess fuel may be conveyed back into the fuel delivery module 3 from the internal combustion engine, as indicated by an arrow 12. For this purpose, the return line conduit 10 is connected for fluid transmission to one end of a fuel return line 13 in the form of a hose or hydraulic line. The fuel return line 13 has an open, free end 14, which is situated in the fuel delivery module 3 and from which the fuel fed back from the internal combustion engine is transported into the fuel delivery module 3.

As also shown in FIGS. 1 and 3, an additional line or auxiliary line 15 is passed through the tank flange 7 into the fuel tank 2. A delivery conduit 16 and an auxiliary connection piece 17, supplies one or more auxiliary units (not shown) with fuel from the fuel tank 2. The auxiliary connection piece 17 may further comprise or connect to a manifold for distributing fuel from the fuel tank 2 to a plurality of auxiliary units. Such auxiliary units could include a heater, a generator, or other fuel-powered systems.

The auxiliary line 15 has a tank end 18 and a suction opening, or inlet 19. In the case of the fuel tank 2, according to the prior art illustrated in FIG. 1, the line inlet 19 is arranged as a tubular opening in the tank end of the auxiliary line 15, wherein the tank end terminus 18 and thus also the inlet 19 are suspended at a distance from a fuel tank bottom 20, as seen in FIG. 2.

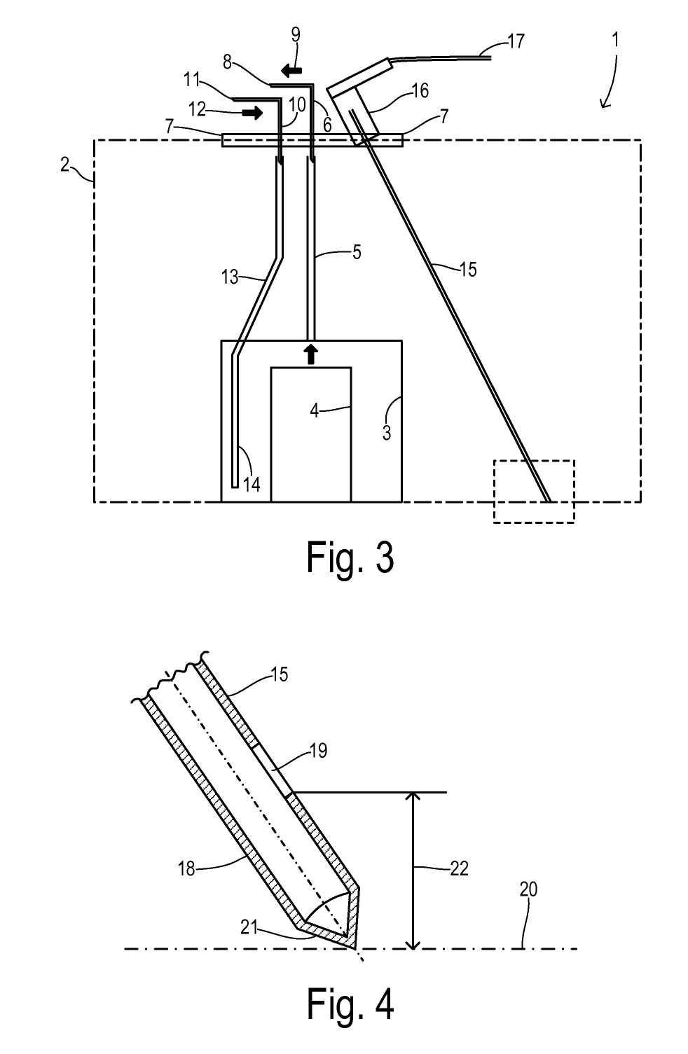

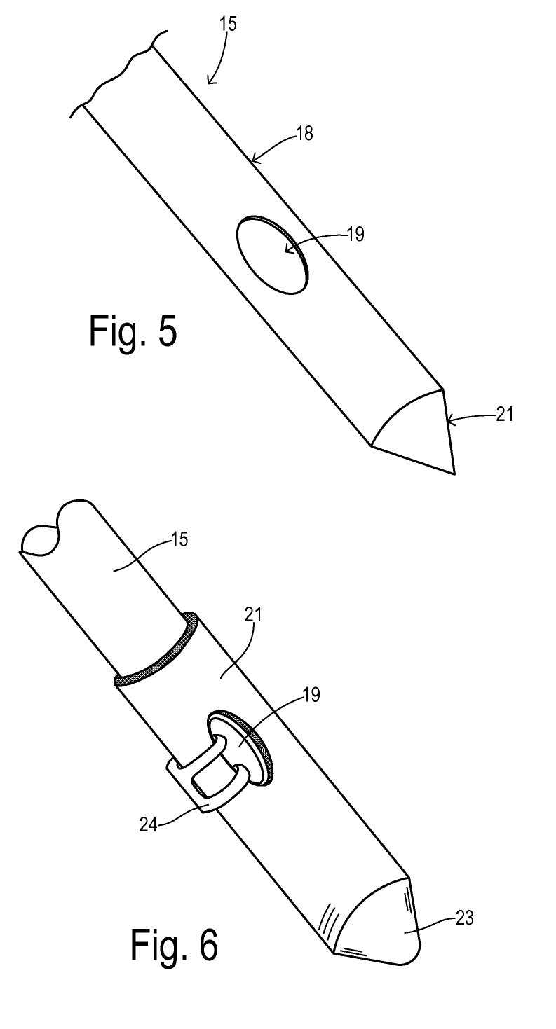

In contrast, the tank end terminus 18 of the auxiliary line 15, according to the invention, as shown in FIGS. 3 and 4 is in contact with the fuel tank bottom 20. The inlet 19 is shown in a wall of the auxiliary line 15 at a distance from the tank end terminus 18, as illustrated in FIGS. 3-6. In this embodiment, the inlet 19 is a side or lateral opening and has an oval configuration, although other geometrical shapes of the inlet 19 in the wall are possible. The inlet may further comprise a plurality of lateral openings.

As seen in FIGS. 4-6, the auxiliary line 15 has a closure 21 at the tank end terminus 18, closing or covering the tank end terminus 18. In the embodiments shown, the closure 21 is conical, tapering from a base along the auxiliary line to the tip of the cone. Thus, the auxiliary line 15 rests the side or tip of the conical closure 21, at least partially on the fuel tank bottom 20 at the tank end terminus 18 of the auxiliary fuel pick up line 15.

The described configuration aids in maintaining the distance 22 between the inlet 19 and the tank bottom 20 over time as the components wear. The inlet 19 in the side wall of the auxiliary line 15 is at substantially the same distance from the fuel tank bottom 20 and maintains the distance 22.

The relative position is maintained within a narrow tolerance if changes in actual position, such as the position of the fuel tank bottom 20, or aging of the auxiliary line 15 change the absolute position. The inlet 19 remains in substantially the same position relative to the fuel tank bottom 20 at all times. In the situation illustrated in FIG. 4, raising of the tank end terminus 18 relative to the fuel tank bottom 20 is shown. As the fuel tank bottom 20 has shifted downward somewhat over time, the auxiliary line 15 has righted itself at the tank end terminus 18 thereof, with the result that the remaining fuel volume, which would then be below the inlet 19, would be substantially unchanged relative to an initial situation. Thus, the tank end terminus 18 and hence the auxiliary line 15 follows the possible changes in position of the fuel tank bottom 20. To allow these movements, the auxiliary line 15 can have a curved or coiled shape in the section extending from the tank flange 7 in the direction of the fuel tank bottom 20. Thus, it can also be somewhat longer than in illustrated in FIG. 3, with its linear auxiliary line 15.

For use and installation, the inlet 19 can be added into the auxiliary line shortly before installation in the fuel tank 2. Moreover, the length of the auxiliary line can be adapted by cutting to length prior to attachment at the flange 7 opposite the closed tank end terminus 18. Thus, the number of auxiliary lines to be stocked can be reduced since the auxiliary line length can be adapted individually.

Through the direct and substantially uninterrupted contact of the auxiliary line 15 with the fuel tank bottom 20 by means of the tank end terminus 18, troublesome impact noises may be avoided. The distance between the inlet 19 and the fuel tank bottom 20 is maintained so that there is also sufficient fuel in the fuel tank 2, allowing the internal combustion engine to be operated at all times, even if it is no longer possible to supply the auxiliary unit with fuel, since the inlet is arranged above the low fuel level. Fuel starvation of the auxiliary unit or units can be taken by the operator as an indicator to fill up the fuel tank 2 since there may be only slightly more than the reserve quantity in the fuel tank. In this way, operation of the internal combustion engine for propulsion is prioritized and the fuel tank is not completely emptied by operation of the auxiliary unit or units.

FIG. 6 shows an attachable closure 21. The embodiment shown has a conical tip 23 which is rounded. A fastener 24 is shown attaching the closure 21 to the auxiliary line 15 at the inlet 19. Other attachment placements and methods may be used alone or in combination, such as hot welding, screw-on, clamping, clipping, gluing, riveting, strapping, and the like.

Embodiments include a fuel tank pick up auxiliary line 15 having an inlets 19 in a side or lateral opening into a wall of the auxiliary line 15 at a distance from a tank end terminus 18, wherein the tank end terminus 18 rests on a fuel tank bottom 20. The inlet 19, may comprise a plurality of openings. At least one auxiliary line 15 is provided for supplying auxiliary units with fuel from the fuel tank 2.

Embodiments include a fuel tank comprising at least one auxiliary line 15 for supplying auxiliary units with fuel from the fuel tank. The at least one auxiliary line 15 has a tank end terminus 18 and inlet 19. The tank end is in the interior of the fuel tank 2. The inlet 19 is configured to permit fuel flow through a wall of the auxiliary line 15 at a distance from the tank end terminus 18 of the auxiliary line 15. The tank end terminus 18 and inlet 19 is dimensioned such that there is an inflow distance 22 between the inlet and the tank bottom 20. The inflow distance 22 is configured so that an internal combustion engine can be supplied with sufficient fuel, even if the auxiliary unit or units can no longer be supplied with fuel. When the fuel level falls below the level of the inlet 19 on the auxiliary line 15, the fuel volume remaining and accessible through the primary fuel line 5 in the fuel tank 2 would be sufficient for starting and/or operating the internal combustion engine.

In an embodiment, the tank end terminus 18 of the at least one auxiliary line rests on the bottom 20 of the fuel tank 2. The inlet 19 is one or more side or lateral openings into the wall of the auxiliary line at a vertical distance from the tank end. Contaminants that may have settled on or near the bottom of the tank can be excluded by optional use of a filter provided to protect the tank end against the influx of such contaminants.

Since the tank end terminus 18 rests on the fuel tank bottom from the outset, the inlet 19 is supported at or near the same distance from the fuel tank bottom. Thus, the amount of fuel required for the internal combustion engine remains in the fuel tank, even if the auxiliary unit or units are being operated with fuel from the fuel tank. The remaining amount of fuel should not be confused with a supplemental reserve amount of fuel which may be provided by other structures and methods. The inlet is arranged that the remaining fuel level is preferably arranged above the reserve fuel level or apart from a separate reserve tank. In this way, the remaining amount of fuel could be regarded as an addition to the reserve amount of fuel. It is also possible for the amount of fuel remaining, due to the height at which the inlet is arranged, to be identical with the reserve fuel level. Thus, the inlet 19 can be arranged at a variable height at a distance from the tank end terminus 18 in the auxiliary line 15 during installation, such that the fuel volume below the inlet remains, once set, substantially unchanged over the life of the internal combustion engine and/or of the fuel tank.

An advantage of the direct contact between the tank end terminus of the auxiliary line and the fuel tank bottom includes reducing deformation of the auxiliary line. The auxiliary line is supported in position at two ends and not subject to substantial pull or torsion. Fastening in the tank flange or in the tank shell is provided and the auxiliary line is supported by its tank end terminus on the fuel tank bottom. If the fuel tank bottom does fall, the tank end of the auxiliary fuel pick up line can follow the tank bottom in the event of variations by contact with the fuel tank bottom and the angle of the cover surface. Thus, the inlet remains in substantially the same position relative to the fuel tank bottom, and a fuel volume remaining below the auxiliary line inlet in the fuel tank is virtually unchanged relative to the initial volume.

In some embodiments, the angle between the axis and generatrix of the conical tip is between about 15-60 degrees. In some embodiments, the angle between the axis and generatrix of the conical tip is between about 20-50 degrees. In some embodiments, the angle of the tip of the cone, bisected along the axis of symmetry, would describe a right angle. In some embodiments, the angle of the tip of the cone would describe an acute angle. In some embodiments, the angle of the tip of the cone would describe an obtuse angle.

Closing the auxiliary line at the tank end terminus 18, and locating the inlet as a side or lateral opening into the wall of the auxiliary line at a distance from the tank end terminus 18, reduces the likelihood of contamination influx. Additionally, the inlet, the one or more side or lateral openings, or the cover may further comprise a screen and/or filter. The at least one auxiliary line, with the tank end terminus 18 abutting the bottom of the fuel tank, has a tank end is closed by means of a closure 21. The closure 21 aids to prevent entry of contaminants deposited on the fuel tank bottom.

In an embodiment, a cover element or closure can be connected in a suitable manner to the auxiliary line as a separate attachable unit in order to close the tank end terminus 18. The closure 21 can be composed of the same kind of material as the auxiliary line or from a different kind of material. The closure 21 may be screwed and/or welded to the tank end, or connected by other methods. Clamping, optionally with subsequent welding, is another method. The auxiliary line may be formed from a fuel-resistant material, such as a plastic, and the closure 21 can likewise be formed from a fuel-resistant plastic. In another embodiment, the closure 21 can be integral with the auxiliary line, and the cover may be co-formed with the auxiliary line as a single unit.

To enable the closed tank end terminus 18 to adjust to changes in the fuel tank bottom easily, a facilitating shape is sloped in the manner of a cone, wherein the closure 21 tapers, i.e. narrows to a point or rounded point, at the tank end. Thus, the tank end, i.e. the closure 21, has a shape matched to possible aging of the material of the auxiliary line 15 and also to possible variations in the fuel tank bottom level. The conical shape compensates for possible changes in position, with the inlet 19 remaining substantially in a set position relative to the fuel tank bottom 20. Thus the fuel volume capacity below the inlet remains substantially unchanged despite possible changes in position of the fuel tank bottom and/or of the auxiliary line. Also, the auxiliary line can have a curved or angled shape. It can be longer than the direct straight-line connection from the tank flange to the fuel tank bottom, thereby providing motion compensation conducive to maintaining the fuel volume below the inlet unchanged.

In some embodiments, an auxiliary line 15 is measured, compared to a fuel tank depth, cut to a length, and a closure 21 attached to a distal end of the line by a fastener 24. An inlet 19 is cut, drilled, pre-formed, or shaped into a lateral surface or side wall of at least one of the closure 21 and the auxiliary line 15. The proximal end of the auxiliary line is attached to a connection at a fuel tank flange 7. The distal end of the closure is sealed against flow and shaped to abut the fuel tank bottom 20. The combined closure and line length is such that a part of the closure rests against the fuel tank bottom. In some embodiments the closure has a conical tip 23. In some embodiments the side of the cone of the conical tip 23 rests against the fuel tank bottom.

The at least one auxiliary line 15 can be secured on the tank flange 7. At the distal tank end, the at least one auxiliary line 15 has an inlet 19 near and spaced away from the tank end terminus 18. At the proximal flange end, the auxiliary line 15 can have a delivery conduit 16, which pumps or sucks fuel from the fuel tank. A plurality of auxiliary lines can be provided, which supply respective auxiliary units, or one single auxiliary line may be in the fuel tank and branch, on the outside of the tank, in order to supply various auxiliary units.

The terms and expressions which have been employed are used as terms of description and not of limitation. Many of the features presented individually in the description can be combined with other features and known structures and methods to give rise to further embodiments of the invention. Whenever a range is given in the specification, all intermediate ranges and subranges, as well as all individual values included in the ranges given are intended to be included in the disclosure. It should be understood that, although the present invention has been specifically disclosed by particular embodiments and examples, optional features, modification and variation of the concepts herein disclosed may be used by those skilled in the art, and such modifications and variations are considered to be within the scope of the invention as defined by the appended claims.

What is claimed is:

1. A motor vehicle fuel tank comprising:
at least one auxiliary line configured to supply at least one auxiliary unit with fuel from the fuel tank,
the auxiliary line further comprising: an inlet formed by at least one lateral opening into a wall of the auxiliary line at a distance from a tank end terminus of the auxiliary line, and
a closure at the tank end terminus configured to abut a fuel tank bottom.

2. The tank of claim 1 wherein the auxiliary line further comprises: a conical closure at the tank end terminus.

3. The tank of claim 1 wherein a distance between the inlet and the fuel tank bottom corresponds to a fuel volume capacity of about 3-20 liters when the vehicle is level.

4. The tank of claim 1 further comprising: a fastener attaching the closure to the auxiliary line.

5. The tank of claim 1 further comprising a manifold, connected to a fuel tank flange, and configured to channel fuel from the auxiliary line to a plurality of auxiliary units.

6. The tank of claim 1 further comprising: a filter at the inlet to the auxiliary line.

7. A method of minimizing deformation in an auxiliary fuel pick up line in a motor vehicle fuel tank, comprising:
attaching a proximal end of the auxiliary line to a flange;
placing a distal end of the auxiliary line on a fuel tank bottom, wherein the distal end further comprises a conical closure.

8. The method of claim 7 further comprising providing an inlet in a side wall of the auxiliary line.

9. A method of compensating for dimensional changes in a motor vehicle fuel tank, comprising:
attaching a conical closure to a distal end of an auxiliary fuel pick up line; and
placing the conical closure at a fuel tank bottom.

10. The method of claim 9 further comprising: providing an inlet in a side wall of the auxiliary fuel pick up line.
